(19) United States
(12) Patent Application Publication
(10) Pub. No.: US 2024/0210642 A1
(43) Pub. Date: Jun. 27, 2024

(54) MICRO-CABLE, MANUFACTURING METHOD THEREFOR, AND FILLING DEVICE

(71) Applicant: JIANGSU ZHONGTIAN TECHNOLOGY CO., LTD., Nantong, Jiangsu (CN)

(72) Inventors: Jing ZHAO, Nantong, Jiangsu (CN); Xiaoming MIAO, Nantong, Jiangsu (CN); Huihui QIAN, Nantong, Jiangsu (CN); Bin MIAO, Nantong, Jiangsu (CN); Feng TAN, Nantong, Jiangsu (CN); Xinjian LI, Nantong, Jiangsu (CN)

(21) Appl. No.: 18/567,510

(22) PCT Filed: Sep. 6, 2021
(86) PCT No.: PCT/CN2021/116614

§ 371 Date: Dec. 6, 2023

(30) Foreign Application Priority Data
Jun. 17, 2021 (CN) 202110674719.3

(51) Int. Cl. G02B 6/44

(52) U.S. Cl. CPC G02B 6/4432; G02B 6/4483; G02B 6/4486; G02B 6/449

(57) ABSTRACT

A micro-cable, a manufacturing method therefor, and a filling device, which relate to the technical field of micro-cables, the micro-cable being used for transmitting signals. The micro-cable comprises a cable core and an outer sheath covering the peripheral surface of the cable core, wherein the cable core comprises a central strengthening member, a plurality of optical units and a sealant, with the plurality of optical units being twisted around the central strengthening member, and twisting gaps between the plurality of optical units being filled with the sealant. Further provided is a method for manufacturing the micro-cable. The filling device comprises a sealant-injection and stranding mold, a sealant injection valve, a sealant pump, and an air source, wherein the sealant-injection and stranding mold is internally provided with a filling channel and a sealant injection channel.

### CROSS-REFERENCE TO RELATED APPLICATION

The present disclosure claims the priority of the patent disclosure with the disclosure number 202110674719.3 and entitled “MICRO-CABLE, MANUFACTURING METHOD THEREFOR, AND FILLING DEVICE” filed to the China Patent Office on Jun. 17, 2021, the entire contents of which are incorporated herein by reference.

### TECHNICAL FIELD

The present disclosure relates to the technical field of micro-cables, and in particular relates to a micro-cable, a manufacturing method therefor, and a filling device.

### BACKGROUND

Micro-cables, also known as micro-optical cables, are usually smaller in outer diameter and lighter in weight than traditional optical cables with the same number of cores when their optical performance is the same. Therefore, micro-optical cables are becoming increasingly widely used.

Micro-cables are able to be laid by air blowing. During the process of laying the micro-cables by air blowing, a sub-pipe is blown into an already laid main pipe by compressed air. Then, according to development needs, the micro-cables are blown into the sub-pipe in batches by compressed air. The main pipe is usually a silicon core pipe, the sub-pipe is usually a high-density polyethylene pipe, and the main pipe and sub-pipe are able to protect the micro-cables. The laying method by air blowing is able to simplify a construction process and save construction costs.

However, the micro-cable easily deforms during the process of blowing the micro-cable into the sub-pipe, thus damaging the performance of the micro-cable.

### SUMMARY

The objective of the present disclosure is to provide a micro-cable, a manufacturing method therefor, and a filling device, which are used for reducing damage to the performance of the micro-cable during the process of blowing the micro-cable into a sub-pipe.

In the first aspect, the present disclosure discloses a micro-cable, which comprises a cable core and an outer sheath covering the peripheral surface of the cable core, wherein the cable core comprises a central strengthening member, a plurality of optical units and a sealant, the plurality of optical units being twisted around the central strengthening member, and twisting gaps between the plurality of optical units being filled with the sealant.

Based on the above technical content, the micro-cable disclosed in the present disclosure comprises the cable core and the outer sheath, the outer sheath covers the peripheral surface of the cable core, the cable core comprises the central strengthening member and the plurality of optical units twisted around the central strengthening member, and the twisting gaps between the plurality of optical units is filled with the sealant. The twisting gaps between the optical units are able to be fully filled with the sealant, and the sealant bonds with the optical units, the outer sheath, and other parts without leaving gaps in the area enclosed by the outer sheath. There are no gaps in the area enclosed by the outer sheath, so pressure difference is not able to be generated between the internal and external air. Moreover, the sealant is able to bear large pressure after being cured, and is able to maintain a balance of force inside and outside the outer sheath when the micro-cable is laid by air blowing, and the micro-cable will not deform or just have a very small deformation. Therefore, during the process of blowing the micro-cable into a sub-pipe, the damage to the performance of the micro-cable is reduced.

In some embodiments, materials of the sealant comprise an active resin, a thickener, and a tackifier, the thickener and the tackifier being uniformly mixed in the active resin.

In some embodiments, the sealant has a hardness of 35 HA −45 HA, and a density of 1.2 g/cm³-1.4 g/cm³ after being cured.

In some embodiments, each optical unit comprises an optical fiber bundle which comprises a plurality of optical fibers and a curable resin, and the plurality of optical fibers are distributed in a bundle shape at intervals in the curable resin.

In some embodiments, the curable resin is a heat curable resin; and the each optical unit further comprises a secondary coating layer covering the peripheral surface of the optical fiber bundle, a material of the secondary coating layer comprising polybutylene terephthalate, and a thickness of the secondary coating layer being 0.1 mm-0.3 mm.

In some embodiments, the number of optical fibers in each optical fiber bundle is 12 or 24;
when the number of optical fibers in each optical fiber bundle is 12, a diameter of the each optical fiber bundle is 0.9 mm-1.2 mm, and a diameter of each optical unit is 1.3 mm-1.7 mm; and
when the number of optical fibers in each optical fiber bundle is 24, a diameter of the each optical fiber bundle is 1.4 mm-1.7 mm, and a diameter of the each optical unit is 1.6 mm-2.3 mm.

In some embodiments, the curable resin is a light curable resin which comprises a base resin, a photosensitizer, and an activator, the photosensitizer and the activator being uniformly mixed in the base resin.

In some embodiments, the number of optical fibers in each optical fiber bundle is 12 or 24;
when the number of optical fibers in each optical fiber bundle is 12, a diameter of the optical fiber bundle is 1.0 mm-1.5 mm; and
when the number of optical fibers in each optical fiber bundle is 24, a diameter of the optical fiber bundle is 1.5 mm-2.0 mm.

In some embodiments, materials of the outer sheath comprise at least one of polyurethane elastomer, polyvinyl chloride, thermoplastic elastomer, and thermoplastic polyester elastomer; and the thickness of the outer sheath is 0.4 mm-0.8 mm.

In the second aspect, the present disclosure discloses a filling device, which comprises a sealant-injection and stranding mold, a sealant injection valve, a sealant pump, and an air source, wherein the sealant-injection and stranding mold is internally provided with a filling channel and a sealant injection channel,
the filling channel comprises a filling inlet and a filling outlet, a central strengthening member and a plurality of optical units penetrate into the filling channel from the filling inlet and out of the filling channel from the filling outlet; an end of the sealant injection channel communicates with the sealant injection valve, and an other end communicates with the filling channel; the sealant pump and the air source both communicate with the sealant injection valve;
the sealant pump is used for pumping a sealant into the sealant injection valve; the air source is used for adjusting an air pressure in the sealant injection valve to control a sealant dispensing speed of the sealant injection valve; and the filling channel is used for filling twisting gaps between the plurality of optical units with the sealant.

Based on the above technical content, in the filling device disclosed in the present disclosure, the sealant is pumped into the sealant injection valve by the sealant pump; the sealant outlet speed of the sealant injection valve is controlled by the air source; the sealant is injected into a sealing channel by the sealant injection valve; and the sealant passes through the sealing channel and the filling channel and finally fills the twisting gaps between the optical units in the filling channel. By such disposition, since the sealant outlet speed of the sealant injection valve is able to be adjusted, the twisted gaps between the plurality of optical units is able to be fully filled with the sealant, and the air tightness of the cable core is improved.

In the third aspect, the present disclosure discloses a method for manufacturing a micro-cable, which comprises following steps:
providing a central strengthening member and a plurality of optical fibers;
evenly laying out the plurality of optical fibers, and making the plurality of optical fibers to pass through a stranding mold, so that the plurality of optical fibers are arranged in a bundle shape at intervals;
pulling the plurality of optical fibers arranged in a bundle shape at intervals into a coating mold, so that the plurality of optical fibers are distributed in a bundle shape at intervals in a curable resin to form an uncured optical fiber bundle;
making the uncured optical fiber bundle to pass through a curing device to form a cured optical fiber bundle;
pulling the cured optical fiber bundle into a first extrusion mold, and extruding a secondary coating layer on a peripheral surface of the cured optical fiber bundle, the cured optical fiber bundle and the secondary coating layer together forming one optical unit;
twisting a plurality of optical units around the central strengthening member, and filling twisting gaps between the optical units with a sealant, the central strengthening member, the plurality of optical units, and the sealant together forming a cable core; and
extruding an outer sheath on a peripheral surface of the cable core, the outer sheath and the cable core together forming a micro-cable.

Based on the above technical contents, the method for manufacturing a micro-cable comprises the following steps: providing the central strengthening member and the plurality of optical fibers; evenly laying out the plurality of optical fibers, and making the plurality of optical fibers to pass through the stranding mold, so that the plurality of optical fibers are arranged in a bundle shape at intervals; pulling the plurality of optical fibers arranged in a bundle shape at intervals into the coating mold, so that the plurality of optical fibers are distributed in a bundle shape at intervals in the curable resin to form the uncured optical fiber bundle; making the uncured optical fiber bundle to pass through the curing device to form the cured optical fiber bundle; pulling the cured optical fiber bundle into the first extrusion mold, and extruding the secondary coating layer on the peripheral surface of the cured optical fiber bundle, the cured optical fiber bundle and the secondary coating layer together forming the optical unit; twisting the plurality of optical units around the central strengthening member, and filling the twisting gaps between the plurality of optical units with the sealant, the central strengthening member, the plurality of optical units, and the sealant together forming the cable core; and extruding the outer sheath on the peripheral surface of the cable core, the outer sheath and the cable core together forming the micro-cable. In the micro-cable formed by the above steps, the twisting gaps between the optical units are able to be fully filled with the sealant, and the sealant bonds with the optical units, the outer sheath, and other parts without leaving gaps in the area enclosed by the outer sheath. There are no gaps in the area enclosed by the outer sheath, so pressure difference is not able to be generated between the internal and external air. Moreover, the sealant is able to bear large pressure after being cured, and is able to maintain a balance of force inside and outside the outer sheath when the micro-cable is laid by air blowing, and the micro-cable will not deform or just have a very small deformation. Therefore, during the process of blowing the micro-cable manufactured by the above steps into a sub-pipe, the damage to the micro-cable is small.

In some embodiments, a step of pulling the cured optical fiber bundle into the extrusion mold to form the secondary coating layer on the peripheral surface of the cured optical fiber bundle comprises:
performing vacuum pumping treatment on an extrusion channel of the extrusion mold to control a tightness between the secondary coating layer and the cured optical fiber bundle.

In some embodiments, in the step of twisting the plurality of optical units around the central strengthening member, and filling the twisting gaps between the plurality of optical units with the sealant, the aforementioned filling device is used.

### BRIEF DESCRIPTION OF THE DRAWINGS

FIG. 1 is a schematic diagram of the structure of a micro-cable provided in an embodiment of the present disclosure.

FIG. 2 is a schematic diagram of the structure of a cable core provided in an embodiment of the present disclosure.

FIG. 3 is a schematic diagram of the structure of a filling device provided in an embodiment of the present disclosure.

### Description of Numerals

10: Cable core; 11: Optical unit
111: Optical fiber; 112: Curable resin;
113: Secondary coating layer; 12: Central strengthening member;
13: Sealant; 20: Outer sheath;
30: Sealant-injection and stranding mold; 31: Filling channel;
32: Sealant injection channel; 40: Sealant injection valve;
50: Sealant pump; 60: Air source.

### Detailed Description of the Embodiments

In related technologies, a micro-cable includes a cable core and an outer sheath covering the cable core. The cable core includes a plurality of optical units that are twisted together, and twisting gaps between the plurality of optical units are filled with a plurality of cable yarns. There are gaps between the plurality of cable yarns, and there are also gaps between the cable yarns, the optical units, and the outer sheath, resulting in gaps in the area enclosed by the outer sheath. When the micro-cable is laid by air blowing, the air pressure outside the outer sheath of the micro-cable is large, while the air pressure in the gaps in the area enclosed by the outer sheath is relatively small, and the pressure difference between the air inside and outside the outer sheath causes deformation of the micro-cable. In addition, during the actual laying process by air blowing, there may be micropores on the surface of the outer sheath, causing the air outside the outer sheath to enter the area enclosed by the outer sheath along the micropores and move along the gaps in the area enclosed by the outer sheath, ultimately leading to bulging or even bursting of the outer sheath, and damaging the performance of the micro-cable.

In response to the above problem, in the micro-cable provided in the embodiments of the present disclosure, the twisting gaps between a plurality of optical units are filled with a sealant, and the sealant is able to fill the twisting gaps between the optical units and bond with the optical units, the outer sheath, and other parts without leaving gaps in the area enclosed by the outer sheath. When the micro-cable is laid by air blowing, there is no air in the area enclosed by the outer sheath, so there will be no pressure difference between the inner and outer air. Moreover, the sealant is able to bear large pressure after being cured. Even if there are structures such as bubbles inside the sealant, the sealant is still able to maintain a balance of force inside and outside the outer sheath, and the micro-cable will not deform or just deform slightly. In addition, even if there may be micropores on the surface of the outer sheath, since there are no gaps in the area enclosed by the outer sheath, the air outside the outer sheath is not able to continue to move after entering the area enclosed by the outer sheath along the micropores, and the outer sheath will not experience bulging and bursting, thereby reducing the damage to the performance of the micro-cable during the process of blowing the micro-cable into a sub-pipe.

To make the objective, characteristics, and advantages of the embodiments of the present disclosure more obvious and easier to understand, the technical solutions in the embodiments of the present disclosure will be clearly and fully described below in conjunction with the accompanying drawings in the embodiments of the present disclosure. Obviously, the described embodiments are merely part rather than all of the embodiments of the present disclosure. Based on the embodiments of the present disclosure, all other embodiments obtained by those of ordinary skill in the art without creative efforts shall fall within the protection scope of the present disclosure.

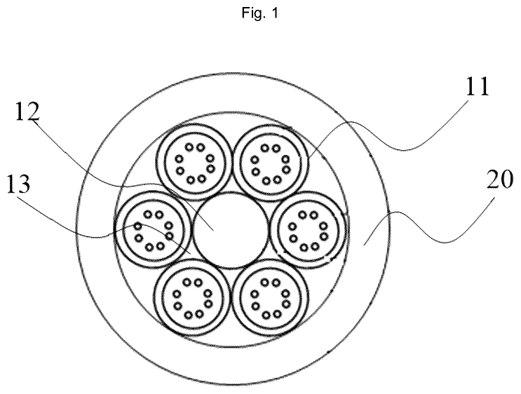

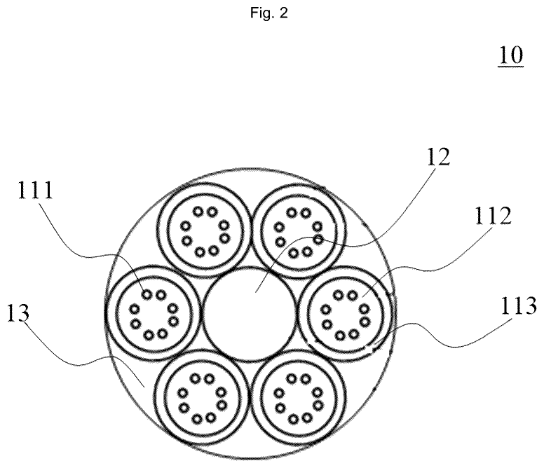

As shown in FIG. 1 and FIG. 2, the embodiments of the present disclosure provide a micro-cable which includes a cable core 10 and an outer sheath 20 covering a peripheral surface of the cable core 10. The cable core 10 includes a central strengthening member 12, a plurality of optical units 11, and a sealant 13. The plurality of optical units 11 are twisted around the central strengthening member 12, and twisting gaps between the plurality of optical units 11 are filled with the sealant 13.

By such disposition, the twisting gaps between the plurality of optical units 11 are able to be fully filled with the sealant 13, and the sealant 13 bonds with the optical units 11, the outer sheath 20, and other parts without leaving gaps in an area enclosed by the outer sheath 20. Moreover, the sealant 13 is able to bear large pressure after being cured. When the micro-cable is laid by air blowing and it makes the air pressure outside the outer sheath 20 large, the sealant 13 is able to support the outer sheath 20 to maintain a balance of force inside and outside the outer sheath 20, and the micro-cable will not deform or just deform slightly. In addition, even if there are micropores on a surface of the outer sheath 20, and the air outside the outer sheath 20 enters the area enclosed by the outer sheath 20 along the micropores, since there are no gaps in the area, the air is not able to continue to move in the sealant 13, and the outer sheath 20 will not experience bulging and bursting, thereby reducing the damage to the performance of the micro-cable during the process of blowing the micro-cable into the sub-pipe.

As shown in FIG. 1, the micro-cable provided in the embodiments of the present disclosure includes a cable core 10, which is circular in shape and includes a central strengthening member 12. By disposing the central strengthening member 12, the tensile strength of the micro-cable is able to be improved.

In a specific embodiment, the central strengthening member 12 is a glass fiber reinforced plastic rod, with an elastic modulus of greater than or equal to 52 GPa and a tensile strength of greater than or equal to 1100 Mpa. By such disposition, the central strengthening member 12 has high stiffness and tensile strength, and the adhesive force between the central strengthening member 12 and the sealant 13 is large.

The micro-cable provided in the embodiments of the present disclosure further includes a plurality of optical units 11 twisted around the central strengthening member 12. The plurality of optical units 11 are able to be twisted in a unidirectional S-mode, with a twisting pitch of 100 mm-500 mm, and the laying tension of the optical units 11 during twisting is 3 N-5 N. The diameter of the optical units 11 and the diameter of the central strengthening member 12 are able to be the same or different. In the present embodiment, the diameter of the optical units 11 is the same as the diameter of the central strengthening member 12. By such disposition, the roundness of the cable core 10 formed by twisting the plurality of optical units 11 around the central strengthening member 12 is improved.

The number of optical units 11 per micro-cable is able to be set according to the capacity of the micro-cable required for transmitting data. For example, the number of optical units 11 is 6-24. Referring to FIG. 1, in a specific implementation, the number of the central strengthening member 12 is 1, and the number of optical units 11 is 6.

Each optical unit 11 includes an optical fiber bundle, which is circular in shape. The optical fiber bundle includes curable resin 112 and a plurality of optical fibers 111 distributed in a bundle shape at intervals in the curable resin 112. By such disposition, after the curable resin 112 is cured, the optical fibers 111 with not move relative to the curable resin 112 during laying the micro-cable by air blowing, and the micro-cable has good stability of performance. In related technologies, optical fibers are placed in an ointment, and due to the fluidity of the ointment, when a micro-cable is laid by air blowing, the optical fibers will move relative to the ointment, resulting in poor stability of the performance of the micro-cable.

In some implementations, the curable resin 112 is a heat curable resin, and has a viscosity of 3000-4500 mPa·S at 25° C. before being cured, and a hardness (HA) of about 20-35 after being cured, thereby ensuring that the optical fiber bundle after being cured has a certain degree of viscoelasticity and flexibility after being cured without affecting the transmission performance of the optical fibers 111.

The heat curable resin includes the following components in parts by weight: 75-88 parts of an acrylic monomer, 3-5 parts of ultrafine silica powder with the surface treated with a silane coupling agent, 3-5 parts of a heat cured accelerator melamine, 1-5 parts of an aromatic hydrocarbon solvent, and 5-10 parts of a second polymer additive, wherein the second polymer additive includes at least one of ethylene glycol, propylene glycol, benzoate, adipate, and phthalate.

In other implementations, the curable resin 112 is a light curable resin, and has a viscosity of 4000 mPa·S-5500 mPa·S and a density of 1.10 g/cm³-1.13 g/cm³ at 25° C. before being cured; the light curable resin has a hardness (HD) of about 55-77 after being cured; and the light curable resin has an elastic modulus of 400 MPa-800 MPa and an elongation at break of greater than or equal to 40% at an elasticity of 2.5% and 23° C. after being cured.

In some embodiments, the materials of the light curable resin include a base resin, a photosensitizer, an activator, and other polymer additives, wherein the photosensitizer and the activator are uniformly mixed in the base resin. The photosensitizer is able to initiate polymerization when the light curable resin is under ultraviolet light irradiation, so that the optical fibers are coated with the light curable resin, forming a circular cured optical fiber bundle. For example, the base resin is a polyacrylic resin, the photosensitizer is a UV initiator, and the activator is a UV active curing agent. The light curable resin includes the following components in parts by weight: 85-92 parts of the polyacrylic resin, 2-5 parts of the UV active curing agent, 4-8 parts of the UV initiator, 1-2 parts of an antioxidant, and 1-3 parts of a third polymer additive, wherein the third polymer additive includes at least one of isopropanol, n-butanol, methyl salicylate, oxamide, and benzoate.

Furthermore, when the curable resin 112 is the heat curable resin, since the heat curable resin has a low hardness after being cured, to improve the deformation resistance of the optical unit 11, the optical unit 11 further includes a secondary coating layer 113 covering a peripheral surface of the optical fiber bundle. When the curable resin 112 is the light curable resin, since the light curable resin has a high hardness after being cured, it is not necessary to extrude the secondary coating layer 113 on a peripheral surface of the optical fiber bundle, thus simplifying the process flow.

In the present embodiment, the material of the secondary coating layer 113 is polybutylene terephthalate, and the thickness of the secondary coating layer 113 is 0.1 mm-0.3 mm. In other embodiments, the material of the secondary coating layer 113 may also be a thermoplastic polymer such as nylon, polycarbonate, and thermoplastic polyester elastomer (TPU, TPEE).

In the actual production and manufacturing process, the secondary coating layer 113 is able to be formed on the peripheral surface of the optical fiber bundle by extrusion. Since the secondary coating layer 113 and the curable resin 112 are both polymer materials that are able to be tightly combined, even if the micro-cable is under large air pressure during the process of laying the micro-cable by air blowing, the optical fiber bundle and the secondary coating layer 113 will not slip, thereby improving the air tightness and water resistance of the optical unit 11. In addition, a surface structure of the secondary coating layer 113 is able to be controlled through a mold, so that the surface of the optical unit 11 is smooth and round.

The optical fibers 111 in the optical fiber bundle may be different types of optical fibers such as G.652 optical fibers and G.657 optical fibers. In the present embodiment, the optical fibers 111 are G.652 optical fibers. The optical fiber 111 includes a fiber core and a coating layer, wherein the fiber core is inside the coating layer; the coating layer is able to directly cover the peripheral surface of the fiber core, or an intermediate layer such as a silicon glass cladding covers the peripheral surface of the fiber core; and the coating layer covers a peripheral surface of the outermost intermediate layer.

For example, the optical fibers 111 are colored optical fibers, and the optical fibers 111 are able to be colored in blue, orange, green, brown, gray, white, red, black, yellow, purple, pink, and cyan. The use of the colored optical fibers is beneficial for distinguishing different optical fibers.

The optical fibers 111 may be smaller size optical fibers of which a diameter of the coating layer is 180 μm-200 μm, and may also be larger size optical fibers of which a diameter of the coating layer is 245 μm-255 μm. In the present embodiment, the diameter of the coating layer of the optical fibers 111 is 245 μm-255 μm.

The number of optical fibers 111 of each optical fiber bundle is able to be set according to the capacity of the micro-cable required for transmitting data. For example, the each optical fiber bundle includes 1-24 optical fibers 111, and the total number of the optical fibers in the micro-cable is able to be 12-576. The plurality of optical fibers 111 in the optical fiber bundle are distributed in a bundle shape at intervals.

Taking 12-fiber and 24-fiber optical units 11 as examples, the size of the optical units 11 will be further introduced, wherein the 12-fiber refers to 12 optical fibers 111 included in an optical unit 11, and the 24-fiber refers to 24 optical fibers 111 included in an optical unit 11.

When the optical unit 11 includes 12-fiber and the curable resin 112 is a heat curable resin, the optical unit 11 further includes a secondary coating layer 113 covering the peripheral surface of the optical fiber bundle, the diameter of the optical unit 11 is 1.3 mm-1.7 mm, the diameter of the optical fiber bundle is 0.9 mm-1.2 mm, and the thickness of the secondary coating layer 113 is 0.1 mm-0.3 mm.

When the optical unit 11 includes 24-fiber and the curable resin 112 is a heat curable resin, the optical unit 11 further includes a secondary coating layer 113 covering the peripheral surface of the optical fiber bundle, the diameter of the optical unit 11 is 1.6 mm-2.3 mm, the diameter of the optical fiber bundle is 1.4 mm-1.7 mm, and the thickness of the secondary coating layer 113 is 0.1 mm-0.3 mm.

When the optical unit 11 includes 12-fiber and the curable resin 112 is a light curable resin, it is not necessary to dispose the secondary coating layer 113 outside the optical fiber bundle, the diameter of the optical fiber bundle is the diameter of the optical unit 11, and the diameter of the optical fiber bundle is 1.0 mm-1.5 mm.

When the optical unit 11 includes 24-fiber and the curable resin 112 is a light curable resin, it is not necessary to dispose the secondary coating layer 113 outside the optical fiber bundle, the diameter of the optical fiber bundle is the diameter of the optical unit 11, and the diameter of the optical fiber bundle is 1.5 mm-2.0 mm.

Referring to FIG. 1 and FIG. 2, the cable core 10 provided in the embodiments of the present disclosure further includes a sealant 13 with which twisting gaps between a plurality of optical units 11 are filled, and a pneumatic pressure filling device is able to be used for filling with the sealant 13. By such disposition, the twisting gaps between the plurality of optical units 11 are able to be fully filled with the sealant 13, and the sealant 13 bonds with the optical units 11, the outer sheath 20, the central strengthening member 12, and other parts without leaving gaps in the area enclosed by the outer sheath 20. Moreover, the sealant 13 is able to bear large pressure after being cured. When the micro-cable is laid by air blowing and it makes the air pressure outside the outer sheath 20 large, the sealant 13 is able to support the outer sheath 20 to maintain a balance of force inside and outside the outer sheath 20, and the micro-cable will not deform. In addition, even if there are micropores on the surface of the outer sheath 20, and the air outside the outer sheath 20 enters the area enclosed by the outer sheath 20 along the micropores, since there are no gaps in the area, the air may not continue to move in the sealant 13, and the outer sheath 20 will not experience bulging and bursting, thereby ensuring normal operation of the micro-cable.

Furthermore, the sealant 13 also has the function of water resistance, so that full cross-section water resistance and air tightness of the micro-cable are achieved, and the micro-cable is able to be laid underwater. The sealant 13 may be a single-component composite cross-linked at room temperature or a dual-component composite cross-linked at room temperature, with excellent thixotropy and cold filling performance at room temperature, and no shrinkage after being cured. In the present embodiment, the sealant 13 is a single-component composite cross-linked at room temperature, and includes an active resin, a thickener, and a tackifier, wherein the thickener and the tackifier are uniformly mixed in the active resin. In the actual manufacturing process, the thickener and the tackifier are able to be uniformly mixed in the active resin through a homogenization process.

The dual-component composite cross-linked at room temperature is able to be obtained by mixing two different single-component composites cross-linked at room temperature in a required proportion. The single-component and dual-component are able to be understood as the types of active resins.

In a specific embodiment, the active resin is a polymer polyacrylic resin, the tackifier is ethylene-propylene diene monomer, and the thickener is fumed silica. The sealant 13 includes the following components in parts by weight: 15-35 parts of the polymer polyacrylic resin, 45-60 parts of basic synthetic polyolefin oil, 5-10 parts of the ethylene-propylene diene monomer, 5-10 parts of the fumed silica, 1-3 parts of an antioxidant, 1-3 parts of a dispersant, 3-5 parts of a water blocking agent, and 3-5 parts of a first polymer additive. The first polymer additive includes at least one of azelate, benzoate, epoxy fatty acid ester, polybutadiene, N-methylolacrylamide and hydroxyethyl methacrylate.

In some embodiments, the sealant 13 forms a deformable rubber body after being cured, with a hardness of 35 HA −45 HA and a density of 1.2 g/cm³-1.4 g/cm³ after being cured. During the process of laying the micro-cable by air blowing, the rubber body is able to absorb some impact force, thereby protecting the structure of the cable core 10 and ensuring normal operation of the micro-cable. In addition, the sealant 13 after being cured also has the characteristics of water pressure impact resistance, no stickiness, easy peeling, good flexibility, adhesion with nylon, polyurethane materials and the central strengthening member 12, good compatibility with the micro-cable material, good air tightness, high water resistance, and the like. Therefore, the micro-cable will not have a large deformation during the laying process by air blowing, thereby ensuring normal operation of the micro-cable. For example, the usage temperature of the sealant 13 after being cured is −60° C. to 220° C.

Referring to FIG. 1, the micro-cable provided in the embodiments of the present disclosure further includes an outer sheath 20 covering the peripheral surface of the cable core 10, and the outer sheath 20 is able to protect the structure of the cable core 10 and improve the mechanical strength of the micro-cable.

The material of the outer sheath 20 is at least one of polyurethane elastomer, polyvinyl chloride, thermoplastic elastomer, and thermoplastic polyester elastomer. The outer sheath 20 is able to adhere to the sealant to avoid gaps between the cable core 10 and the outer sheath 20. The outer sheath 20 is able to be formed by extrusion. Specifically, an extrusion mold used for extrusion of the outer sheath 20 is a squeezing mold. By such disposition, the combination between the cable core 10 and the outer sheath 20 is closer, thereby making the structure of the micro-cable more compact and the surface smoother.

The micro-cable provided in the embodiments of the present disclosure does not need to be filled with an ointment during the production process, and has a fully dry structure. Compared to a semi-dry structured micro-cable filled with the ointment in related technologies, the micro-cable provided in the embodiments of the present disclosure has less environmental pollution and is conducive to optical fiber connection and more convenient for construction.

Furthermore, to adapt the micro-cable to an underwater environment, the longitudinal water tightness of the micro-cable provided in the embodiments of the present disclosure meets a requirement of no water leakage under a water pressure of 1 MPa-4 MPa, and the cable core 10 does not slip relative to the outer sheath 20. Moreover, to avoid damage to the micro-cable during the laying process by air blowing, the air tightness of the micro-cable provided in the embodiments of the present disclosure meets a requirement that under a pressure of 0 Bar-10 Bar, the cable core 10 does not slip significantly relative to the outer sheath 20, the outer sheath 20 does not rupture, or even the surface of the outer sheath 20 already has cracks, the cracks will not expand.

The following is an example of a 72-fiber micro-cable provided in the embodiments of the present disclosure, and specifically the structure of the micro-cable provided in the embodiments of the present disclosure will be introduced. The 72-fiber micro-cable refers to a micro-cable including 72 optical fibers 111. As shown in FIG. 1, the 72-fiber micro-cable includes a cable core 10 and an outer sheath 20 covering the cable core 10. The cable core 10 includes a central strengthening member 12 and 6 optical units 11, and the 6 optical units 11 are twisted around the central strengthening member 12. Each optical unit 11 includes an optical fiber bundle and a secondary coating layer 113. The optical fiber bundle includes a heat curable resin and 12 optical fibers 111 of which the coating layer has a diameter of about 245 μm-255 μm, and the secondary coating layer 113 is formed by coating the peripheral surface of the optical fiber bundle with polybutylece terephthalate. The diameter of the 12-fiber optical fiber bundle is 0.9 mm-1.2 mm, the diameter of the optical unit 11 is 1.3 mm-1.7 mm, and the thickness of the secondary coating layer 113 is 0.1 mm-0.3 mm. The central strengthening member is a glass fiber reinforced plastic rod, and has an elastic modulus of greater than or equal to 52 GPa and a tensile strength of greater than or equal to 1100 Mpa. The diameter of the central strengthening member 12 is consistent with the diameter of the optical unit 11 to ensure the roundness of the cable core 10 after twisting. The twisting gaps between the plurality of optical units 11 are filled with a sealant 13, and the sealant 13 has a sealing function and water resistance. The size of the cable core 10 of the 72-fiber micro-cable is 4.2 mm-5.1 mm, and the outer sheath 20 is made of a polyurethane elastomer material. The thickness of the outer sheath 20 is 0.4 mm-0.8 mm, and the diameter of the 72-fiber micro-cable is 5.0 mm-6.6 mm.

In some embodiments, some optical units 11 may also be replaced by a certain number of filling elements based on the transmission capacity of the micro-cable required, so that the total number of optical fibers in the micro-cable is 12-72. Taking the aforementioned 72-fiber micro-cable as an example, if less transmission capacity of the micro-cable is required and only 4 optical units 11 are needed, 2 excess optical units 11 are able to be replaced with 2 filling elements, thereby reducing the cost of the micro-cable. At this time, the micro-cable is a 48-fiber micro-cable. In addition, the number of the optical units 11 of the micro-cable may be 6-24, each optical unit 11 may include 4 to 24 fibers, and the total number of fibers of the micro-cable is able to be 12-576, making for flexible adjustment of the transmission capacity of the micro-cable within a certain range.

The embodiments of the present disclosure further provide a filling device for filling the twisting gaps between the plurality of optical units 11 with the sealant 13 in the above embodiments.

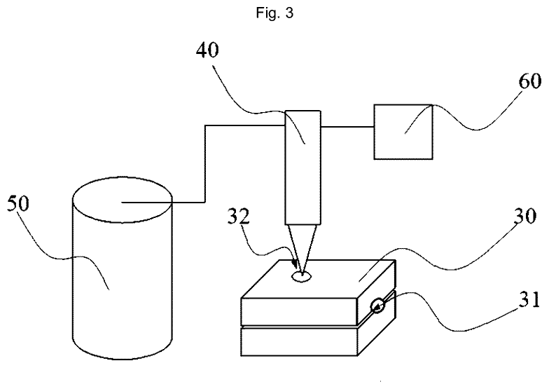

As shown in FIG. 3, the filling device provided in the embodiments of the present disclosure includes a sealant-injection and stranding mold 30, a sealant injection valve 40, a sealant pump 50, and an air source 60, wherein the sealant-injection and stranding mold 30 is internally provided with a filling channel 31 and a sealant injection channel 32.

In some embodiments, the sealant-injection and stranding mold 30 includes an upper mold and a lower mold. A lower end of the upper mold is provided with a first channel, and an upper end of the lower mold is provided with a second channel. When the lower end of the upper mold is attached to the upper end of the lower mold, the first channel and the second channel together form the filling channel 31, and the sealant injection channel 32 that communicates with the filling channel 31 is formed in the upper mold.

The filling channel 31 includes a filling inlet and a filling outlet, and the central strengthening member 12 and the plurality of optical units 11 penetrate into the filling channel 31 from the filling inlet and out of the filling channel 31 from the filling outlet. The twisting gaps between the plurality of optical units 11 are filled with the sealant 13. One end of the sealant injection channel 32 communicates with the sealant injection valve 40, specifically, one end of the sealant injection channel 32 communicates with a nozzle of the sealant injection valve 40, and the other end communicates with the filling channel 31. The sealant pump 50 and the air source 60 both communicate with the sealant injection valve 40.

The sealant pump 50 is used for pumping the sealant 13 into the sealant injection valve 40. The air source 60 is used for adjusting the air pressure in the sealant injection valve 40 to control a sealant dispensing speed of the sealant injection valve 40. The filling channel 31 is used for filling the twisting gaps between the plurality of optical units 11 with the sealant 13.

During actual filling, the central strengthening member 12 and the plurality of optical units 11 are allowed to pass through the filling channel 31 and move along a length direction of the filling channel 31. At the same time, the plurality of optical units 11 are twisted around the central strengthening member 12. During the twisting process, the twisting gaps between the plurality of optical units 11 are filled with the sealant 13 which flows out of the sealant injection valve 40 and passes through the sealant injection channel 32 and the filling channel 31. The central strengthening member 12 and the plurality of optical units 11 are able to initially form a cable core 10 after being twisted and filled.

The filling device provided in the embodiments of the present disclosure adjusts the air pressure in the sealant injection valve 40 through the air source 60, thereby controlling the sealant dispensing speed of the sealant injection valve 40, ensuring that the gaps of the cable core 10 are able to be completely filled with the sealant 13, and improving the performance of the cable core 10.

Furthermore, a cable passing mold is disposed at the filling outlet, and the size of the cable passing mold is able to be designed according to the size of the cable core 10. By providing the cable passing mold, excess sealant on the surface of the cable core 10 is removed. In addition, the cable core 10 after passing through the cable passing mold is able to be pulled into a heating device to accelerate a curing process of the sealant 13.

The embodiments of the present disclosure further provide a method for manufacturing a micro-cable, including the following steps:
a central strengthening member and a plurality of optical fibers are provided, wherein the optical fibers are colored optical fibers, and the optical fibers are able to be colored in blue, orange, green, brown, gray, white, red, black, yellow, purple, pink, and cyan, and the use of the colored optical fibers is beneficial for distinguishing different optical fibers;
the plurality of optical fibers are evenly laid out, and the plurality of optical fibers are allowed to pass through a stranding mold, so that the plurality of optical fibers are arranged in a bundle shape at intervals, wherein the tension during laying the optical fibers is able to be a constant tension in a range of 50-80 N;
the plurality of optical fibers arranged in a bundle shape at intervals are pulled into a coating mold, so that the plurality of optical fibers are distributed in a bundle shape at intervals in a curable resin to form an uncured optical fiber bundle;
the uncured optical fiber bundle is pulled to a curing device to form a cured optical fiber bundle;
the cured optical fiber bundle is pulled into a first extrusion mold, and a secondary coating layer is extruded on a peripheral surface of the cured optical fiber bundle, wherein the cured optical fiber bundle and the secondary coating layer together form an optical unit;
a plurality of optical units are twisted around the central strengthening member, and the twisting gaps between the plurality of optical units are filled with a sealant, wherein the central strengthening member, the plurality of optical units, and the sealant together form a cable core; and
an outer sheath is extruded on the peripheral surface of the cable core, wherein the outer sheath and the cable core together form a micro-cable. Specifically, the outer sheath is extruded on the peripheral surface of the cable core using a second extrusion mold, and the second extrusion mold is a squeezing mold.

In the above process, the stranding mold, the coating mold, the curing device, and the extrusion mold are able to be disposed on the same horizontal line, which is conducive to ensuring consistent laying tension on the optical fibers and reducing the attenuation coefficient of the optical fibers.

In some embodiments, the step of pulling the cured optical fiber bundle into the first extrusion mold and extruding the secondary coating layer on the peripheral surface of the cured optical fiber bundle includes:
vacuum pumping treatment is performed on an extrusion channel of the extrusion mold to control the tightness between the secondary coating layer and the cured optical fiber bundle, wherein the vacuum pumping treatment is able to be performed using a vacuum pumping machine, and the tightness between the secondary coating layer and the cured optical fiber bundle is able to be controlled by the vacuum degree displayed on the vacuum pumping machine. Such disposition is able to ensure good air tightness and water resistance between the secondary coating layer of the optical fibers and the each optical fiber bundle by adjusting the vacuum pressure, making the surface of the optical unit smooth and the appearance round.

In some embodiments, in the step of twisting the plurality of optical units around the central strengthening member, and filling the twisting gaps between the plurality of optical units with the sealant, the filling device in the above embodiment is able to be used, and the laying tension during twisting the plurality of optical units is controlled at 3 N-5 N. Specifically, the central strengthening member and the plurality of optical units are allowed to pass through the filling channel and move along the length direction of the filling channel. At the same time, the plurality of optical units are twisted around the central strengthening member. During the twisting process, the twisting gaps between the plurality of optical units are filled with the sealant which flows out of the sealant injection valve and passes through the sealant injection channel and the filling channel. The central strengthening member and the plurality of optical units are able to initially form a cable core after being twisted and filled.

The initially formed cable core is able to pass through the cable passing mold at the filling outlet of the filling channel to remove excess sealant from the surface of the cable core and improve the roundness of the cable core.

Due to use of the aforementioned filling device, the method for manufacturing a micro-cable provided in the present embodiment is able to adjust the air pressure in the sealant injection valve through the air source, thereby ensuring that the twisting gaps between the plurality of optical units are able to be completely filled with the sealant, and improving the performance of the micro-cable.

In some possible embodiments, after the cable core passes through the cable passing mold, a step of feeding the cable core into a heating device is also included to accelerate curing of the cable core.

For example, the above product embodiments are able to be referred to for the structure and materials of the micro-cables in the above method embodiments, and will not be repeated here.

In the description, the embodiments or implementations are described in a progressive manner, and each embodiment focuses on the differences from other embodiments. The same and similar parts between the embodiments are able to be referred to each other.

Those skilled in the art should understand that in the disclosure of the present disclosure, the terms “longitudinal”, “transverse”, “up”, “down”, “front”, “back”, “left”, “right”, “vertical”, “horizontal”, “top”, “bottom”, “inside”, “outside”, etc. refer to the orientation or position relationship based on the orientation or position relationship shown in the accompanying drawings, which is only for the convenience of describing the present disclosure and simplifying the description, rather than indicating or implying that the systems or components referred to must have a specific orientation, or be constructed and operated in a specific orientation. Hence, the above terms may not be understood as limiting the present disclosure.

In the description, the reference terms “one implementation”, “some implementations”, “illustrative implementations”, “examples”, “specific examples”, or “some examples” refer to the specific features, structures, materials, or characteristics described in conjunction with the implementations or examples being included in at least one implementation or example of the present disclosure. In the description, the illustrative expressions of the above terms do not necessarily refer to the same implementations or examples. Moreover, the specific features, structures, materials, or characteristics described may be combined in an appropriate manner in any one or more implementations or examples.

Finally, it should be noted that the above embodiments are only used for describing rather than limiting the technical solutions of the present disclosure. Although the present disclosure has been described in detail with reference to the foregoing embodiments, those of ordinary skill in the art should understand that the technical solutions described in the foregoing embodiments are still able to be modified, or some or all of the technical features are able to be equivalently replaced. And these modifications or replacements do not make the essence of the corresponding technical solutions deviate from the scope of the technical solutions of the embodiments of the present disclosure.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A micro-cable, comprising a cable core and an outer sheath covering a peripheral surface of the cable core, wherein the cable core comprises a central strengthening member, a plurality of optical units and a sealant, the plurality of optical units being twisted around the central strengthening member, and twisting gaps between the plurality of optical units being filled with the sealant.

2. The micro-cable according to claim 1, wherein materials of the sealant comprise an active resin, a thickener, and a tackifier, the thickener and the tackifier being uniformly mixed in the active resin.

3. The micro-cable according to claim 2, wherein the sealant has a hardness of 35 HA-45 HA, and a density of 1.2 g/cm³-1.4 g/cm³ after being cured.

4. The micro-cable according to claim 1, wherein each optical unit comprises an optical fiber bundle, the optical fiber bundle comprises a plurality of optical fibers and a curable resin, and the plurality of optical fibers are distributed in a bundle shape at intervals in the curable resin.

5. The micro-cable according to claim 4, wherein the curable resin is a heat curable resin; and the each optical unit further comprises a secondary coating layer covering the peripheral surface of the optical fiber bundle, a material of the secondary coating layer comprising polybutylene terephthalate, and a thickness of the secondary coating layer being 0.1 mm-0.3 mm.

6. The micro-cable according to claim 5, wherein the number of optical fibers in each optical fiber bundle is 12 or 24; when the number of optical fibers in each optical fiber bundle is 12, a diameter of the each optical fiber bundle is 0.9-1.2 mm, and a diameter of each optical unit is 1.3 mm-1.7 mm; and when the number of optical fibers in each optical fiber bundle is 24, a diameter of the optical fiber bundle is 1.4 mm-1.7 mm, and a diameter of each optical unit is 1.6 mm-2.3 mm.

7. The micro-cable according to claim 4, wherein the curable resin is a light curable resin, the light curable resin comprises a base resin, a photosensitizer, and an activator, the photosensitizer and the activator being uniformly mixed in the base resin.

8. The micro-cable according to claim 7, wherein the number of optical fibers in each optical fiber bundle is 12 or 24; when the number of optical fibers in each optical fiber bundle is 12, a diameter of the optical fiber bundle is 1.0 mm-1.5 mm; and when the number of optical fibers in each optical fiber bundle is 24, a diameter of the optical fiber bundle is 1.5 mm-2.0 mm.

9. The micro-cable according to claim 1,
wherein materials of the outer sheath comprise at least one of polyurethane elastomer, polyvinyl chloride, thermoplastic elastomer, and thermoplastic polyester elastomer; and a thickness of the outer sheath is 0.4 mm-0.8 mm.

10. A filling device, comprising a sealant-injection and stranding mold, a sealant injection valve, a sealant pump, and an air source, wherein the sealant-injection and stranding mold is internally provided with a filling channel and a sealant injection channel, the filling channel comprises a filling inlet and a filling outlet, a central strengthening member and a plurality of optical units penetrate into the filling channel from the filling inlet and out of the filling channel from the filling outlet; a first end of the sealant injection channel communicates with the sealant injection valve, and a second end communicates with the filling channel; the sealant pump and the air source both communicate with the sealant injection valve; the sealant pump is used for pumping a sealant into the sealant injection valve; the air source is used for adjusting an air pressure in the sealant injection valve to control a sealant dispensing speed of the sealant injection valve; and the filling channel is used for filling twisting gaps between the plurality of optical units with the sealant.

11. A method for manufacturing a micro-cable, comprising following steps:
providing a central strengthening member and a plurality of optical fibers;
evenly laying out the plurality of optical fibers, and making the plurality of optical fibers to pass through a stranding mold, so that the plurality of optical fibers are arranged in a bundle shape at intervals;
pulling the plurality of optical fibers arranged in a bundle shape at intervals into a coating mold, so that the plurality of optical fibers are distributed in a bundle shape at intervals in a curable resin to form an uncured optical fiber bundle;
making the uncured optical fiber bundle to pass through a curing device to form a cured optical fiber bundle;
pulling the cured optical fiber bundle into a first extrusion mold, and extruding a secondary coating layer on a peripheral surface of the cured optical fiber bundle, the cured optical fiber bundle and the secondary coating layer together forming one optical unit;
twisting a plurality of optical units around the central strengthening member, and filling twisting gaps between the optical units with a sealant, the central strengthening member, the plurality of optical units, and the sealant together forming a cable core; and
extruding an outer sheath on a peripheral surface of the cable core, the outer sheath and the cable core together forming a micro-cable.

12. The method for manufacturing the micro-cable according to claim 11,
wherein a step of pulling the cured optical fiber bundle into a first extrusion mold, and extruding a secondary coating layer on a peripheral surface of the cured optical fiber bundle comprises: performing vacuum pumping treatment on an extrusion channel of the extrusion mold to control a tightness between the secondary coating layer and the cured optical fiber bundle.

13. The micro-cable according to claim 9, wherein materials of the sealant comprise an active resin, a thickener, and a tackifier, the thickener and the tackifier being uniformly mixed in the active resin.

14. The micro-cable according to claim 9, wherein the sealant has a hardness of 35 HA-45 HA, and a density of 1.2 g/cm³-1.4 g/cm³ after being cured.

15. The micro-cable according to claim 9, wherein each optical unit comprises an optical fiber bundle, the optical fiber bundle comprises a plurality of optical fibers and a curable resin, and the plurality of optical fibers are distributed in a bundle shape at intervals in the curable resin.

16. The micro-cable according to claim 15, wherein the curable resin is a heat curable resin; and the each optical unit further comprises a secondary coating layer covering the peripheral surface of the optical fiber bundle, a material of the secondary coating layer comprising polybutylene terephthalate, and a thickness of the secondary coating layer being 0.1 mm-0.3 mm.

17. The micro-cable according to claim 16, wherein the number of optical fibers in each optical fiber bundle is 12 or 24; when the number of optical fibers in each optical fiber bundle is 12, a diameter of the each optical fiber bundle is 0.9-1.2 mm, and a diameter of each optical unit is 1.3 mm-1.7 mm; and when the number of optical fibers in each optical fiber bundle is 24, a diameter of the optical fiber bundle is 1.4 mm-1.7 mm, and a diameter of each optical unit is 1.6 mm-2.3 mm.

18. The micro-cable according to claim 15, wherein the curable resin is a light curable resin, the light curable resin comprises a base resin, a photosensitizer, and an activator, the photosensitizer and the activator being uniformly mixed in the base resin.

19. The micro-cable according to claim 18, wherein the number of optical fibers in each optical fiber bundle is 12 or 24; when the number of optical fibers in each optical fiber bundle is 12, a diameter of the optical fiber bundle is 1.0 mm-1.5 mm; and when the number of optical fibers in each optical fiber bundle is 24, a diameter of the optical fiber bundle is 1.5 mm-2.0 mm.
